(19) United States
(12) Patent Application Publication
(10) Pub. No.: US 2025/0112221 A1
(43) Pub. Date: Apr. 3, 2025

(54) LITHIUM-BASED BATTERY

(71) Applicant: National Tsing Hua University, Hsinchu City (TW)

(72) Inventors: Chi-Chang HU, Hsinchu City (TW); Chih-Han YEN, Hsinchu City (TW); Li-Qian WANG, Hsinchu City (TW); Chen-Wei TAI, Hsinchu City (TW); Hao-Yu KU, Hsinchu City (TW)

(73) Assignee: National Tsing Hua University, Hsinchu City (TW)

(21) Appl. No.: 18/979,045

(22) Filed: Dec. 12, 2024

Related U.S. Application Data
(62) Division of application No. 17/699,677, filed on Mar. 21, 2022.

(30) Foreign Application Priority Data
Jan. 17, 2022 (TW) 111101862

(51) Int. Cl. H01M 4/04; H01M 4/02; H01M 4/1391; H01M 4/36; H01M 10/0525

(52) U.S. Cl. CPC H01M 4/0471; H01M 4/1391; H01M 4/366; H01M 10/0525; H01M 2004/028

(57) ABSTRACT

Provided are a precursor solution, and a modified layer and a lithium-based battery prepared by using the same. The modified layer is formed on the negative electrode, the positive electrode and/or the separator of the lithium-based battery by using the precursor solution through photo-polymerization reaction or thermal curing. The lithium-based battery comprising the modified layer effectively promotes the charge and discharge capability, cycling life, and safety. The modified layer can be applied to a roll-to-roll process. The formation of lithium dendrites in the lithium-based battery comprising the modified layer is significantly suppressed or reduced during the charge-discharge cycles. The shuttle effect is effectively suppressed or reduced in lithium sulfur batteries and lithium iodine batteries. All the above effects are beneficial to increasing the product value of lithium ion batteries, lithium metal batteries, anode-free lithium batteries, lithium sulfur batteries, and lithium iodine batteries.

### CROSS-REFERENCE TO RELATED APPLICATION

Pursuant to 35 U.S.C. § 119(a), this application claims the benefits of the priority to Taiwan Patent Application No. 111101862, filed on Jan. 17, 2022. The contents of the prior application are incorporated herein by its entirety.

### BACKGROUND OF THE INVENTION

### 1. Field of the Invention

The instant disclosure relates to a precursor solution, and a modified layer and a lithium-based battery prepared by using the same.

### 2. Description of the Prior Arts

To solve the problems of energy shortage and increasing demand for electricity, people have put lots of efforts on researches of high performance energy storage systems. Lithium-ion batteries (LIBs) are widely used in various electronic products since they provide the high energy density, high power density, and acceptable charge-discharge cycling life. To further improve the power density of batteries, the lithium metal batteries (LMBs) with a negative electrode of metallic lithium and the anode-free lithium batteries (AFLBs) in which a copper foil serves as the negative electrode are emphasized. Considering the power density and safety, lithium-based batteries also need a proper positive electrode system. Therefore, the development of lithium-based batteries having a negative electrode made of lithium metal or copper foil with a variety of positive electrode systems is urgent and important.

The formation of lithium dendrites is a serious issue in lithium-based batteries (e.g., LMBs and AFLBs) for a long time. In the charge-discharge process of lithium-based batteries, lithium dendrites tend to accumulate on the negative electrode, resulting in the formation of dead lithium, thereby reducing the coulombic efficiency and the charge capacity. Overgrowth of the lithium dendrites may result in internal short circuit and battery explosion, which lowers the safety of lithium-based batteries.

In the studies of charge capacity of lithium-based batteries, it is widely known that the energy density or power density of batteries can be raised by adding an element such as sulfur or iodine in the positive electrode system. However, the reduced ions of sulfur and iodine tend to dissolve in the electrolyte, which results in the shuttle effect. The aforesaid phenomenon decreases the coulombic efficiency and the charge-discharge cycling life of lithium-based batteries.

In view of this, the charge-discharge cycle performance and/or safety of lithium-based batteries remain to be improved.

### SUMMARY OF THE INVENTION

In view of the defects of the prior art, one objective of the instant disclosure is to provide a precursor solution, which can be used to prepare a modified layer by photopolymerization or thermal curing. Another objective of the instant disclosure is to provide a modified layer prepared by the precursor solution. Yet another objective of the instant disclosure is to provide a lithium-based battery comprising the modified layer; wherein the formation of lithium dendrites can be suppressed or reduced in the charge-discharge cycling tests, and this indicates the good safety of such a lithium-based battery.

On the other hand, the lithium-based battery of the instant disclosure has a high coulombic efficiency and long charge-discharge cycling life, which is beneficial to increasing the product value thereof.

On the other hand, in the embodiments of the lithium-based battery of the instant disclosure which comprises sulfur or iodine, the shuttle effect can be suppressed or reduced. Hence, the lithium-based battery of the instant disclosure is beneficial to the development of batteries with high charge capacity and power density and the lithium-based battery of the instant disclosure has the potential to be applied for lithium sulfur battery and lithium iodine battery.

To achieve aforementioned objectives, the instant disclosure provides a precursor solution, comprising an active substance, a lithium salt solution and an initiator;
wherein the active substance is a monomer, an oligomer or a combination thereof;
wherein the monomer is methacrylate ester, lithium methacrylate, acrylate ester, lithium acrylate, trimethylol propane triacrylate or lithium salt of trimethylol propane triacrylate;
wherein the oligomer comprises a constitutional unit represented by

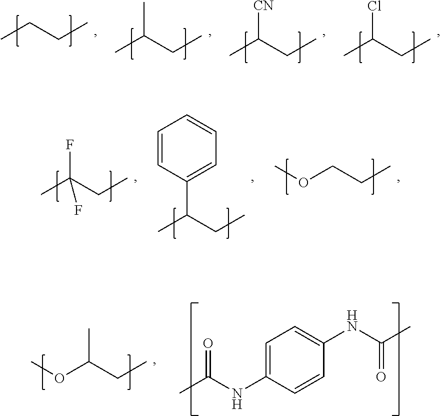

or a combination thereof, and the oligomer comprises an end structure represented by

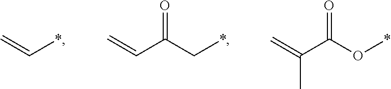

or a combination thereof;
wherein the concentration of the lithium salt solution is 0.5 molar concentration (M) to 4 M;
wherein the initiator is 2,2-dimethoxy-2-phenylacetophenone (DMPA), benzoyl peroxide (BPO), 2,2′-azobis(2-methylpropionitrile) (AIBN), 2-hydroxy-2-methyl-1-phenyl-1-propanone or a combination thereof;
wherein in the precursor solution, the weight of the active substance is 5 percent by weight (wt %) to 47.5 wt %, the weight of the lithium salt solution is 50 wt % to 94.9 wt %, and the weight of the initiator is 0.1 wt % to 5 wt %.

The modified layer can be formed by using the precursor solution of the instant disclosure through photopolymerization or thermal curing. After charge-discharge cycles, the formation of lithium dendrite in the lithium-based battery comprising the modified layer can be suppressed or reduced. Therefore, the lithium-based battery has a high coulombic efficiency and long charge-discharge cycling life, which is beneficial to increasing the product value thereof. On the other hand, in the lithium sulfur battery and lithium iodine battery comprising the modified layer, the shuttle effect caused by sulfur or iodine can be suppressed or reduced, which is beneficial to the developments of lithium sulfur battery and lithium iodine battery.

Preferably, the oligomer may comprise a constitutional unit represented by

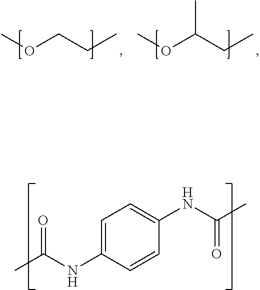

or a combination thereof, and the oligomer may comprise an end structure represented by

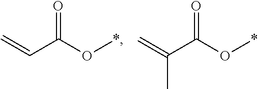

or a combination thereof.

In some embodiments, the oligomer may comprise at least one constitutional unit selected from the group consisting of

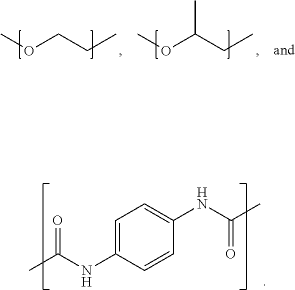

Optionally, the oligomer may comprise a constitutional unit represented by

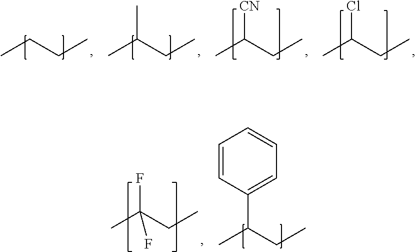

or a combination thereof, and the oligomer may comprise an end structure represented by

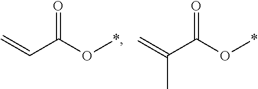

or a combination thereof.

In some embodiments, the oligomer may have a number-average molecular weight (Mn) of 200 to 2500. In some embodiments, the oligomer may have a number-average molecular weight of 500 to 800.

Preferably, the active substance may be polyethylene glycol diacrylate (PEGDA), polypropylene glycol diacrylate, lithium methacrylate, lithium acrylate, trimethylol propane triacrylate or a combination thereof. In some embodiments, the active substance may be the combination of lithium methacrylate and trimethylol propane triacrylate, and the weight ratio of lithium methacrylate to trimethylol propane triacrylate may be 3:7 to 7:3. In some embodiments, the active substance may be the combination of lithium acrylate and trimethylol propane triacrylate, and the weight ratio of lithium acrylate to trimethylol propane triacrylate is 3:7 to 7:3.

In some embodiments, in the precursor solution, the active substance may have an amount of 5 wt % to 20 wt %, the lithium salt solution may have an amount of 75 wt % to 94.9%, and the initiator may have an amount of 0.1 wt % to 5 wt %.

Optionally, in the precursor solution, the lithium salt solution may have an amount of 60 wt % to 94.5%, 75 wt % to 90 wt % or 80 wt % to 90 wt %. Preferably, the lithium salt solution may have a concentration of 0.8 M to 2 M.

Preferably, the lithium salt solution may comprise a lithium salt and an organic solvent, and the organic solvent may be 1,3-dioxolane (DOL), 1,2-dimethoxyethane (DME), ethylene carbonate (EC), ethylene methyl carbonate (EMC), dimethyl carbonate (DMC), vinylene carbonate (VC), tetraethylene glycol dimethyl ether, dimethyl sulfoxide (DMSO), acetonitrile (ACN) or a combination thereof.

Preferably, the lithium salt may be lithium bis(trifluoromethanesulfonyl)imide (LiTFSI), lithium hexafluorophosphate (LiPF₆), lithium tetrafluoroborate (LiBF₄), lithium perchlorate (LiClO₄), lithium triflouoromethanesulfonate (LiOTf), lithium fluoride (LiF), lithium difluorophosphate (LiPO₂F₂), lithium bis(oxalato)borate (LiBOB), lithium difluoro(oxalato)borate (LiDFOB), lithium nitride (Li₃N), or a combination thereof.

Preferably, the initiator may be 2,2-dimethoxy-2-phenylacetophenone.

In some embodiments, the precursor solution may comprise an additive, and the additive may be an organic compound or a metal salt;
wherein the organic compound may be an oligomer comprising at least one of hydroxyl end group or amine end group, polysquarate, succinonitrile, 1,3-propane sultone, prop-1-ene-1,3-sultone, fluoroethylene carbonate, ethylene glycol, polysorbate or a combination thereof;
wherein the oligomer comprising at least one of hydroxyl end group or amine end group may comprise a constitutional unit represented by

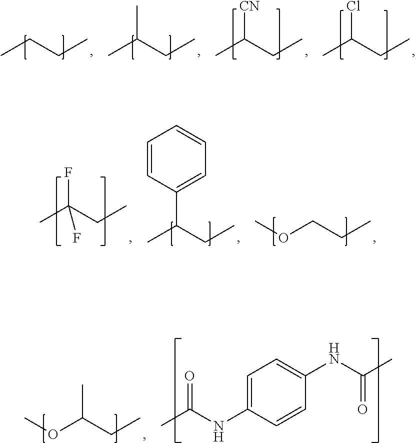

or a combination thereof;
wherein the metal salt is lithium nitrate, sodium nitrate, potassium nitrate or a combination thereof.

In aforesaid embodiment, in the precursor solution, the lithium salt solution may have an amount of 50 wt % to 94.5 wt %, and the additive May have an amount of 0.01 wt % to 30 wt %, 0.01 wt % to 20 wt % or 0.01 wt % to 10 wt %.

In some embodiments, the precursor solution may comprise an additive, and the additive may be an oligomer comprising at least one of hydroxyl end group or amine end group;
wherein the oligomer comprising at least one of hydroxyl end group or amine end group may comprise a constitutional unit represented by

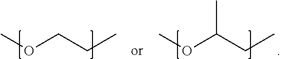

In some embodiments, the precursor solution may comprise an additive, and the additive may be an oligomer comprising at least one of hydroxyl end group or amine end group;
wherein the oligomer comprising at least one of hydroxyl end group or amine end group may be

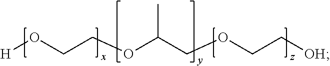

wherein x may be 1 to 20; y may be 1 to 40; z may be 1 to 20; and x, y, and z may be the same or different.

In some embodiments, the precursor solution may comprise a filler, and the filler may be titanium dioxide, silicon dioxide, zirconium dioxide, aluminum oxide, indium tin oxide, lanthanum manganite, lithium sulfide-based particle, lithium oxide-based particle, lithium phosphate-based particle, lithium lanthanum zirconium tantalum oxide (Li_{6.4}La₃Zr_{1.4}Ta_{0.6}O₁₂), lithium lanthanum aluminum zirconium oxide (Li_{6.4}La₃Al_{0.2}Zr₂O₁₂) or a combination thereof, which are inorganic powders having good lithium ion conductivity.

In some embodiment, in the precursor solution, the lithium salt solution may have an amount of 50 wt % to 94.5 wt %, and the filler may have an amount of 0.01 wt % to 40 wt %, 0.01 wt % to 30 wt %, 0.01 wt % to 20 wt % or 0.01 wt % to 10 wt %.

The instant disclosure also provides a modified layer, and the modified layer is formed by using the precursor solution through photopolymerization or thermal curing.

In some embodiments, the modified layer may be applied to a roll-to-roll process.

The instant disclosure also provides a lithium-based battery comprising a positive electrode, a negative electrode, a separator, a lithium electrolyte, and at least one modified layer; wherein the modified layer is formed by curing aforesaid precursor solution, and the modified layer is deposited on the positive electrode, the negative electrode, the separator or a combination thereof. Aforesaid lithium-based battery may be, but is not limited to, a lithium ion battery, a lithium metal battery, an anode-free lithium battery, a lithium sulfur battery or a lithium iodine battery.

In some embodiments, the modified layer may be deposited between the positive electrode and the separator or between the negative electrode and the separator. In some embodiments, the modified layers may be deposited between the positive electrode and the separator and between the negative electrode and the separator, respectively.

In some embodiments, the lithium salt comprised in the modified layer is the same as the lithium salt comprised in the liquid lithium electrolyte. In some embodiments, the lithium salt comprised in the modified layer is different from the lithium salt comprised in the liquid lithium electrolyte. The condition in practice may be modified according to the properties of the positive electrode and the negative electrode, and thus charge capacity, coulombic efficiency, and charge-discharge cycling life are able to be further increased. Specifically, when the positive electrode is made of a lithium nickel manganese cobalt oxide material (NMC material), a lithium salt solution stable at highly positive potentials may be used as the lithium electrolyte to increase the charge-discharge cycling life and the charge capacity of the lithium-based battery, and a lithium salt ether-based solution (beneficial to lithium plating and lithium stripping) may be used as the lithium salt solution comprised in the precursor solution to prepare the modified layer on the negative electrode in order to suppress the formation of lithium dendrites on the negative electrode and to increase the power density and charge-discharge cycling life of the lithium metal battery. When the positive electrode is made of a lithium nickel manganese oxide (LiNi_{0.5}Mn_{0.5}O₂, LNMO) material, a lithium salt solution stable at highly positive potentials may be used as the lithium salt solution comprised in the precursor solution to prepare the modified layer on the positive electrode and a filler (e.g., Li_{6.4}La₃Zr_{1.4}Ta_{0.6}O₁₂, LLZTO) and an additive (e.g., trimethyl borate) which tolerate highly positive potentials may be added to increase the charge-discharge cycling life of the positive electrode, and a commercial lithium salt solution (beneficial to intercalation/deintercalation of lithium ions and usually used with graphite negative electrode) may be used as a liquid electrolyte in the lithium ion battery in order to stabilize the charge/discharge behavior of graphite negative electrode, and to increase the power density and the charge-discharge cycling life of the lithium ion battery.

In some embodiments, the modified layer may comprise a filler, and the filler may be titanium dioxide, silicon dioxide, zirconium dioxide, aluminum oxide, indium tin oxide, lanthanum manganite, lithium sulfide-based particle, lithium oxide-based particle, lithium phosphate-based particle or a combination thereof. The modified layer in aforesaid embodiments can effectively increase the contact of the positive electrode to the electrolyte and the contact of the negative electrode to the electrolyte, and reduce the degradation of the electrolyte during the high voltage charge-discharge cycles at highly positive potentials.

In some embodiments, the lithium-based battery may comprise sulfur or iodine.

In some embodiments, the positive electrode may be a lithium nickel oxide-based electrode. Specifically, the lithium nickel oxide-based electrode may be a lithium nickel manganese cobalt oxide electrode (NMC) or a lithium nickel cobalt aluminum oxide electrode (NCA).

Besides, the modified layer of the instant disclosure may be applied to an anode-free lithium battery. In some embodiments, the modified layer of the instant disclosure is deposited on the surface of the negative electrode, and the impedance caused by lithium metal precipitating and stripping on the negative electrode after 30 charge-discharge cycles is obviously reduced. Hence, the modified layer can increase the performance of charge-discharge cycle and/or safety of anode-free lithium batteries.

### BRIEF DESCRIPTION OF THE DRAWING(S)

FIG. 1 is the charge/discharge cycle graph of the lithium metal battery of Example 1B.

FIG. 2 is the charge/discharge cycle graph of the lithium metal battery of Example 2B.

FIG. 3A to FIG. 3C are the charge/discharge cycle graphs of the lithium metal batteries of Examples 3B-1 to 3B-3 in order.

FIG. 4 is a galvanostatic cycling voltage profile (current density: 0.5 mA/cm² or 1 mA/cm²) of lithium-lithium symmetric batteries of Examples 5B-1, 6B-1, 7B, 8B, and Comparative Example 1B from top to bottom.

FIG. 5 is an electrochemical impedance spectroscopy of lithium copper batteries of Examples 4B, 5B-2, 6B-2, and Comparative Example 2B.

FIG. 6A is a galvanostatic charge/discharge cycle graph of lithium iodine battery of Example 6C.

FIG. 6B is a galvanostatic charge/discharge cycle graph of lithium iodine battery of Comparative Example 3C.

FIG. 7A is a photograph of lithium-lithium symmetric battery of Example 9B taken at the 15^{th} minute after the charge-discharge process begins.

FIG. 7B is a photograph of the lithium-lithium symmetric battery of Comparative Example 4B taken at the 15^{th} minute after the charge-discharge process begins.

### DETAILED DESCRIPTION OF THE PREFERRED EMBODIMENTS

Hereinafter, multiple Examples are provided to illustrate the implementations of the precursor solution, the modified layer prepared by curing the precursor solution and the lithium-based battery comprising aforesaid modified layer, while multiple lithium-based batteries are provided as Comparative Examples for comparison. A person having ordinary skills in the art can easily realize the advantages and effects of the instant disclosure from the following Examples and Comparative Examples. The embodiments provided herein are just exemplified for the purpose of illustrations only, not intended to limit the scope of the instant disclosure. Various modifications and variations could be made in order to practice or apply the instant disclosure without departing from the spirit and scope of the instant disclosure.

### Reagents

The active substances, lithium salt solutions, initiator, additives, and filler used in each precursor solution of Examples were listed as follows.

### 1. Active Substances:

(1). PEGDA: polyethylene glycol diacrylate (model: Merck 437411, Mn: 575)
(2). TMPTA: trimethylol propane triacrylate
(3). LiMAA: lithium methacrylate
First, methacrylate was provided as the starting material. Lithium hydroxide solution in methanol was added to neutralize methacrylate till about pH 7. The solvent was removed by rotary evaporator and dried in vacuum oven to give LiMAA.
(4). LiAA: lithium acrylate
First, acrylate was provided as the starting material. Lithium hydroxide solution in methanol was added to neutralize acrylate till about pH 7. The solvent was removed by rotary evaporator and dried in vacuum oven to give LiAA.
(5). PU oligomer: polyurethane oligomer
First, polyether oligomer (product: Pluronic ®L61, abbreviated as L61 hereinafter) and 1,4-phenylene diisocyanate were dissolved in methyl ethyl ketone. Dibutyltin dilaurate (DBTDL) as the catalyst was added, and the reaction was conducted at 60° C. for 6 hours while nitrogen was being introduced as a protective gas to give a PU oligomer intermediate. Afterwards, the temperature was reduced to 40° C., and polypropylene glycol acrylate was added, and the reaction was conducted at 40° C. for 2 hours. The solvent was removed by rotary evaporator and the PU oligomer was yielded.

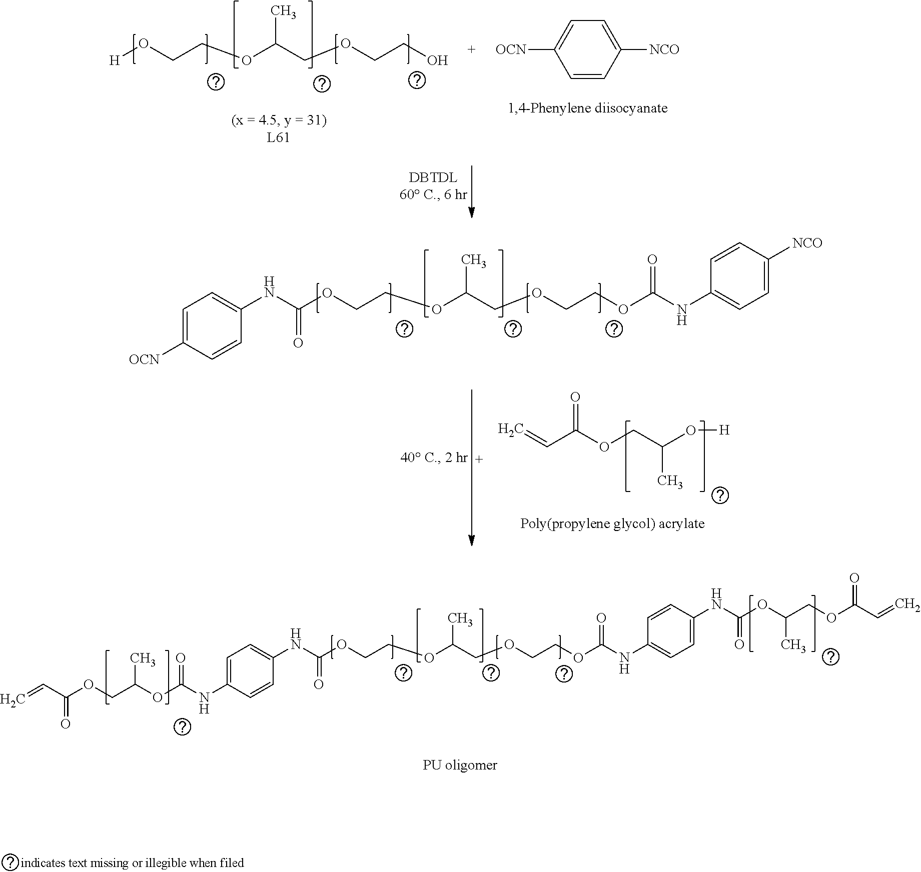

### 2. Lithium Salt Solutions:

(1). 1 M LiTFSI in DOL/DME solution
First, moderate amount of LiTFSI was dissolved in the solution of 1,3-dioxolane and 1,2-dimethoxyethane (with a volume ratio of 1:1) to give 1 M LiTFSI in DOL/DME solution.
(2). 1 M LiPF₆ in DMC/EC solution
First, moderate amount of LiPF₆ was dissolved in the solution of dimethyl carbonate and ethylene carbonate (with a volume ratio of 1:1) to give 1 M LiPF₆ in DMC/EC solution.
(3). 1 M LiPF₆ in EC/EMC/DMC solution (containing 1 vol % VC)
First, moderate amount of LiPF₆ was dissolved in the solution of ethylene carbonate, ethylene methyl carbonate, and dimethyl carbonate (with a volume ratio of 1:1:1) to give 1 M LiPF₆ in EC/EMC/DMC solution (containing 1 vol % VC); wherein the volume of vinylene carbonate (VC) was 1% of aforesaid solution.

### 3. Initiator: 2,2-Dimethoxy-2-Phenylacetophenone (DMPA)

### 4. Additives:

(1). LiNO₃: lithium nitrate;
(2). L61: Pluronic ®L61.
   5. Filler: Aluminum Oxide (Al₂O₃).

### Precursor Solutions

### Examples 1 to (E1 to E9)

In the precursor solutions of Examples 1 to 9, a monomer and/or an oligomer were provided as the starting material and mixed with the chosen lithium salt solution and the initiator. The additives and filler were optionally added to aforesaid mixture. After that, the resulting mixture was stirred evenly for 0.5 hour to 6 hours to give the precursor solutions of Examples. The compositions of Examples 1 to 9 are shown in Table 1.

TABLE 1
Compositions of precursor solutions of Examples 1 to 9 (E1 to E9)

| | Active Substance | | | | |
|---|---|---|---|---|---|
| | (Monomer and/or | Lithium Salt | | Addi- | |
| | Oligomer) | Solution | Initiator | tive | Filler |
| E1 | 10 wt % PEGDA | 88.5 wt % | 0.5 wt % | 1 wt % | — |
| | | 1M LiTFSI in | DMPA | LiNO₃ | |
| | | DOL/DME solution | | | |
| E2 | 10 wt % PEGDA | 89.5 wt % | 0.5 wt % | — | — |
| | | 1M LiPF₆ in | DMPA | | |
| | | DMC/EC solution | | | |
| E3 | 10 wt % PEGDA | 84.25 wt % | 0.75 wt % | 5 wt % | — |
| | | 1M LiPF₆ in | DMPA | L61 | |
| | | DMC/EC solution | | | |
| E4 | 5 wt % TMPTA/ | 89.5 wt % | 0.5 wt % | — | — |
| | 5 wt % PU oligomer | 1M LiPF₆ in EC/EMC/DMC | DMPA | | |
| E5 | 1.5 wt % LiMAA/ | solution | 0.5 wt % | — | — |
| | 3.5 wt % TMPTA/ | (containing | DMPA | | |
| | 5 wt % PU oligomer | 1 vol % VC) | | | |
| E6 | 2.5 wt % LiMAA/ | | 0.5 wt % | — | — |
| | 2.5 wt % TMPTA/ | | DMPA | | |
| | 5 wt % PU oligomer | | | | |
| E7 | 1.5 wt % LiAA/ | | 0.5 wt % | — | — |
| | 3.5 wt % TMPTA/ | | DMPA | | |
| | 5 wt % PU oligomer | | | | |
| E8 | 2.5 wt % LiAA/ | | 0.5 wt % | — | — |
| | 2.5 wt % TMPTA/ | | DMPA | | |
| | 5 wt % PU oligomer | | | | |
| E9 | 1.5 wt % LiMAA/ | 86.5 wt % | 0.5 wt % | 2 wt % | 1 wt % |
| | 3.5 wt % TMPTA/ | 1M LiTFSI in | DMPA | LiNO₃ | Al₂O₃ |
| | 5 wt % PU oligomer | DOL/DME solution | | | |

### Modified Layers

### Examples 1A to 9A (E1A to E9A)

Aforesaid precursor solutions of Examples 1 to 9 were dripped evenly on the positive electrode, the negative electrode or the separator according to different needs, and modified layers of Examples 1A to 9A were formed by curing aforesaid precursor solutions through appropriate illumination.

### Lithium-Based Batteries

The modified layers of Examples were respectively employed together with a negative electrode, a separator, and a positive electrode to give lithium metal batteries, lithium copper batteries, lithium-lithium symmetric batteries of Examples 1B to 9B and lithium iodine battery of Example 6C. The configurations of lithium metal batteries, lithium copper batteries, lithium-lithium symmetric batteries and lithium iodine battery of each Example and the modified layers thereof are described as follows.

### Example 1B

The lithium metal battery of Example 1B was a coin cell. The positive electrode was a lithium nickel manganese cobalt oxide electrode (LiNi_{0.6}Mn_{0.2}Co_{0.2}O₂, abbreviated as NMC622 hereinafter), the negative electrode was a lithium foil (purchased from Shining Energy Co., LTD.), the separator was a commercial polyethylene separator (purchased from Asahi Kasei, model: SUNFIN), and the electrolyte was 70 μL of 1 M LiPF₆ in DMC/EC solution (v/v: 1/1). 10 μL of the precursor solution of Example 1 was dripped evenly on the surface of the lithium foil and cured by illuminating with UV light (wavelength: 365 nm) for 2 minutes to give the modified layer of Example 1A. The modified layer of Example 1A was deposited between the lithium foil and the separator.

### Example 2B

The lithium metal battery of Example 2B was a coin cell. The positive electrode was an NMC622 electrode, the negative electrode was a lithium foil (purchased from Shining Energy Co., LTD.), the separator was a commercial polyethylene separator (purchased from Asahi Kasei, model: SUNFIN), and the electrolyte was 60 μL of 1 M LiPF₆ in DMC/EC solution (v/v: 1/1). 10 μL of the precursor solution of Example 1 was dripped evenly on the surface of the lithium foil and cured by illuminating with UV light (wavelength: 365 nm) for 2 minutes to give the modified layer of Example 1A. 10 μL of the precursor solution of Example 2 was dripped evenly on the surface of the NMC622 electrode and cured by illuminating with UV light (wavelength: 365 nm) for 2 minutes to give the modified layer of Example 2A. The modified layer of Example 1A was deposited between the lithium foil and the separator, and the modified layer of Example 2A was deposited between the NMC622 electrode and the separator.

### Example 3B-1, Example 3B-2, Example 3B-3

The lithium metal battery of Example 3B-1 was a coin cell. The positive electrode was an NMC622 electrode, the negative electrode was a lithium foil (purchased from Shining Energy Co., LTD.), the separator was a commercial polyethylene separator (purchased from Asahi Kasei, model: SUNFIN), and the electrolyte was 70 μL of 1 M LiPF₆ in DMC/EC solution (v/v: 1/1). 10 μL of the precursor solution of Example 3 was dripped evenly on the surface of the lithium foil and cured by illuminating with UV light (wavelength: 365 nm) for 2 minutes to give the modified layer of Example 3A. The modified layer of Example 3A was deposited between the lithium foil and the separator.

The lithium metal battery of Example 3B-2 was the same as the lithium metal battery of Example 3B-1 except that 10 μL of the precursor solution of Example was dripped evenly on the surface of the NMC622 electrode and cured by illuminating with UV light (wavelength: 365 nm) for 2 minutes to give the modified layer of Example 3A in the lithium metal battery of Example 3B-2. The modified layer of Example 3A was deposited between the NMC622 electrode and the separator in the lithium metal battery of Example 3B-2.

The lithium metal battery of Example 3B-3 was the same as the lithium metal battery of Example 3B-1 except that 10 μL of the precursor solution of Example 3 was dripped evenly on the surface of the separator and cured by illuminating with UV light (wavelength: 365 nm) for 2 minutes to give the modified layer of Example 3A in the lithium metal battery of Example 3B-3. The modified layer of Example 3A was deposited between the lithium foil and the separator in the lithium metal battery of Example 3B-3.

### Example 4B

The lithium copper battery of Example 4B was a coin cell. The negative electrode was a lithium foil (purchased from Shining Energy Co., LTD.), the positive electrode was a copper foil (purchased from Shining Energy Co., LTD., model: 1092011), the separator was a commercial polyethylene separator (purchased from Asahi Kasei, model: SUNFIN), and the electrolyte was 80 μL of 1 M LiPF₆ in EC/EMC/DMC solution (v/v/v: 1/1/1) (containing 0.8 μL VC). 15 μL of the precursor solution of Example 4 was dripped evenly on the surface of the copper foil and cured by illuminating with UV light (wavelength: 365 nm) for 2 minutes to give the modified layer of Example 4A. The modified layer of Example 4A was deposited between the copper foil and the separator.

### Example 5B-1, Example 5B-2

The lithium-lithium symmetric battery of Example 5B-1 was a coin cell. The positive electrode and the negative electrode were lithium foils (purchased from Shining Energy Co., LTD.), the separator was a commercial polyethylene separator (purchased from Asahi Kasei, model: SUNFIN), and the electrolyte was 65 μL of 1 M LiPF₆ in EC/EMC/DMC solution (v/v/v: 1/1/1) (containing 0.65 μL VC). Two portions of 15 μL of the precursor solution of Example 5 were dripped evenly on the surfaces of the positive electrode and the negative electrode respectively and cured by illuminating with UV light (wavelength: 365 nm) for 2 minutes to give two modified layers of Example 5A. One modified layer of Example 5A was deposited between the positive electrode and the separator and the other modified layer of Example 5A was deposited between the negative electrode and the separator.

The lithium copper battery of Example 5B-2 was a coin cell. The negative electrode was a lithium foil (purchased from Shining Energy Co., LTD.), the positive electrode was a copper foil (purchased from Shining Energy Co., LTD., model: 1092011), the separator was a commercial polyethylene separator (purchased from Asahi Kasei, model: SUNFIN), and the electrolyte was 80 μL of 1 M LiPF₆ in EC/EMC/DMC solution (v/v/v: 1/1/1) (containing 0.8 μL VC). 15 μL of the precursor solution of Example 5 was dripped evenly on the surface of the copper foil and cured by illuminating with UV light (wavelength: 365 nm) for 2 minutes to give the modified layer of Example 5A. The modified layer of Example 5A was deposited between the copper foil and the separator.

### Example 6B-1, Example 6B-2

The lithium-lithium symmetric battery of Example 6B-1 was a coin cell. The positive electrode and the negative electrode were lithium foils (purchased from Shining Energy Co., LTD.), the separator was a commercial polyethylene separator (purchased from Asahi Kasei, model: SUNFIN), and the electrolyte was 65 μL of 1 M LiPF₆ in EC/EMC/DMC solution (v/v/v: 1/1/1) (containing 0.65 μL VC). Two portions of 15 μL of the precursor solution of Example 6 were dripped evenly on the surfaces of the positive electrode and the negative electrode respectively and cured by illuminating with UV light (wavelength: 365 nm) for 2 minutes to give two modified layers of Example 6A. One modified layer of Example 6A was deposited between the positive electrode and the separator and the other modified layer of Example 6A was deposited between the negative electrode and the separator.

The lithium copper battery of Example 6B-2 was a coin cell. The negative electrode was a lithium foil (purchased from Shining Energy Co., LTD.), the positive electrode was a copper foil (purchased from Shining Energy Co., LTD., model: 1092011), the separator was a commercial polyethylene separator (purchased from Asahi Kasei, model: SUNFIN), and the electrolyte was 80 μL of 1 M LiPF₆ in EC/EMC/DMC solution (v/v/v: 1/1/1) (containing 0.8 μL VC). 15 μL of the precursor solution of Example 6 was dripped evenly on the surface of the copper foil and cured by illuminating with UV light (wavelength: 365 nm) for 2 minutes to give the modified layer of Example 6A. The modified layer of Example 6A was deposited between the copper foil and the separator.

### Example 7B

The lithium-lithium symmetric battery of Example 7B was a coin cell. The positive electrode and the negative electrode were lithium foils (purchased from Shining Energy Co., LTD.), the separator was a commercial polyethylene separator (purchased from Asahi Kasei, model: SUNFIN), and the electrolyte was 65 μL of 1 M LiPF₆ in EC/EMC/DMC solution (v/v/v: 1/1/1) (containing 0.65 μL VC). Two portions of 15 μL of the precursor solution of Example 7 were dripped evenly on the surfaces of the positive electrode and the negative electrode respectively and cured by illuminating with UV light (wavelength: 365 nm) for 2 minutes to give two modified layers of Example 7A. One modified layer of Example 7A was deposited between the positive electrode and the separator and the other modified layer of Example 7A was deposited between the negative electrode and the separator.

### Example 8B

The lithium-lithium symmetric battery of Example 8B was a coin cell. The positive electrode and the negative electrode were lithium foils (purchased from Shining Energy Co., LTD.), the separator was a commercial polyethylene separator (purchased from Asahi Kasei, model: SUNFIN), and the electrolyte was 65 μL of 1 M LiPF₆ in EC/EMC/DMC solution (v/v/v: 1/1/1) (containing 0.65 μL VC). Two portions of 15 μL of the precursor solution of Example 8 were dripped evenly on the surfaces of the positive electrode and the negative electrode respectively and cured by illuminating with UV light (wavelength: 365 nm) for 2 minutes to give two modified layers of Example 8A. One modified layer of Example 8A was deposited between the positive electrode and the separator and the other modified layer of Example 8A was deposited between the negative electrode and the separator.

### Example 9B

The lithium-lithium symmetric battery of Example 9B was a self-designed closed optical microscope battery observation slot. The positive electrode and the negative electrode were lithium foils (purchased from Shining Energy Co., LTD.), and no separator was comprised. The electrolyte was 1 M LiPF₆ in DMC/EC solution (v/v: 1/1) filled within the observation slot (about 8 mL to 10 mL). 2 μL to 3 μL of the precursor solution of Example 9 was dripped evenly on the negative electrode and cured by illuminating with UV light (wavelength: 365 nm) for 1.5 minutes to give the modified layer of Example 9A. The modified layer of Example 9A was deposited on the negative electrode and the modified layer faced to the positive electrode.

### Lithium Iodine Battery

### Example 6C

The lithium iodine battery of Example 6C was a coin cell. The positive electrode was made of an activated carbon fiber (ACF) containing 36 wt % iodine, the negative electrode was a lithium foil (purchased from Shining Energy Co., LTD.), the separator was a commercial polyethylene separator (purchased from Asahi Kasei, model: SUNFIN), and the electrolyte was 70 μL of 1 M LiTFSI in DOL/DME solution (v/v: 1/1) containing 2 wt % LiNO₃. 10 μL of the precursor solution of Example 6 was dripped evenly on the surface of the activated carbon fiber and cured by illuminating with UV light (wavelength: 365 nm) for 1.5 minutes to give the modified layer of Example 6A. The modified layer of Example 6A was deposited between the activated carbon fiber and the separator.

### Comparative Examples 1B, 2B, 3C, 4B (C1B, C2B, C3C, C4B)

### Comparative Example 1B

The lithium-lithium symmetric battery of Comparative Example 1B was a coin cell. The positive electrode and the negative electrode were lithium foils (purchased from Shining Energy Co., LTD.), the separator was a commercial polyethylene separator (purchased from Asahi Kasei, model: SUNFIN), and the electrolyte was 95 μL of 1 M LiPF₆ in EC/EMC/DMC solution (v/v/v: 1/1/1) (containing 0.95 μL VC). The lithium-lithium battery of Comparative Example 1B did not comprise the modified layer of the instant disclosure.

### Comparative Example 2B

The lithium copper battery of Comparative Example 2B was a coin cell. The negative electrode was a lithium foil (purchased from Shining Energy Co., LTD.), the positive electrode was a copper foil (purchased from Shining Energy Co., LTD., model: 1092011), the separator was a commercial polyethylene separator (purchased from Asahi Kasei, model: SUNFIN), and the electrolyte was 95 μL of 1 M LiPF₆ in EC/EMC/DMC solution (v/v/v: 1/1/1) (containing 0.95 μL VC). The lithium copper battery of Comparative Example 2B did not comprise the modified layer of the instant disclosure.

### Comparative Example 3C

The lithium iodine battery of Comparative Example 3C was a coin cell. The positive electrode was made of an activated carbon fiber (ACF) containing 36 wt % iodine, the negative electrode was a lithium foil (purchased from Shining Energy Co., LTD.), the separator was a commercial polyethylene separator (purchased from Asahi Kasei, model: SUNFIN), and the electrolyte was 80 μL of 1 M LiTFSI in DOL/DME solution (v/v: 1/1) containing 2 wt % LiNO₃. The lithium iodine battery of Comparative Example 3C did not comprise the modified layer of the instant disclosure.

### Comparative Example 4B

The lithium-lithium symmetric battery of Comparative Example 4B was a self-designed closed optical microscope battery observation slot. The positive electrode and the negative electrode were lithium foils (purchased from Shining Energy Co., LTD.), and no separator was comprised. The electrolyte was 1 M LiPF₆ in DMC/EC solution (v/v: 1/1) filled within the observation slot (about 8 mL to 10 mL). The lithium-lithium symmetric battery of Comparative Example 4B did not comprise the modified layer of the instant disclosure.

### Test Example 1: Charge-Discharge Cycle Performance

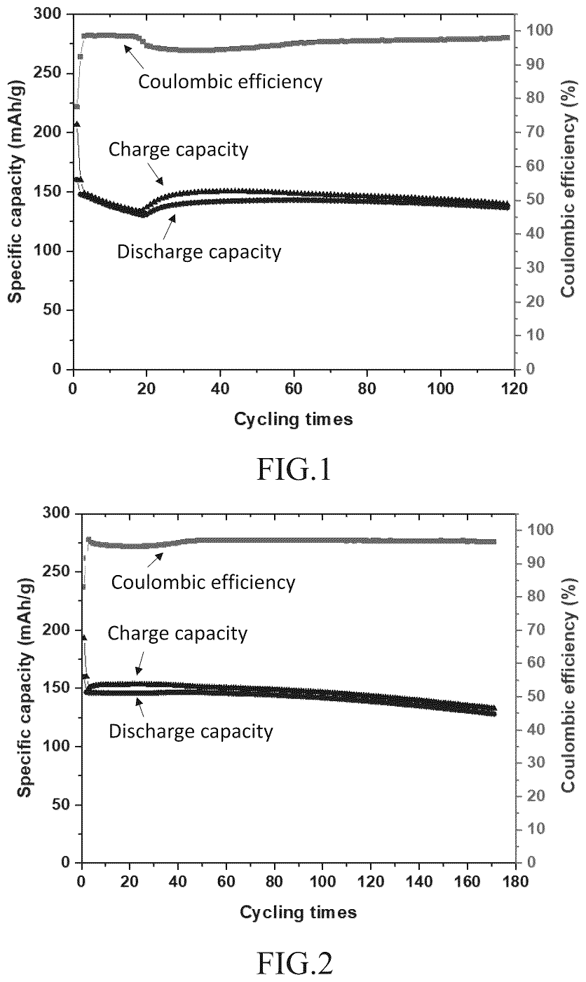

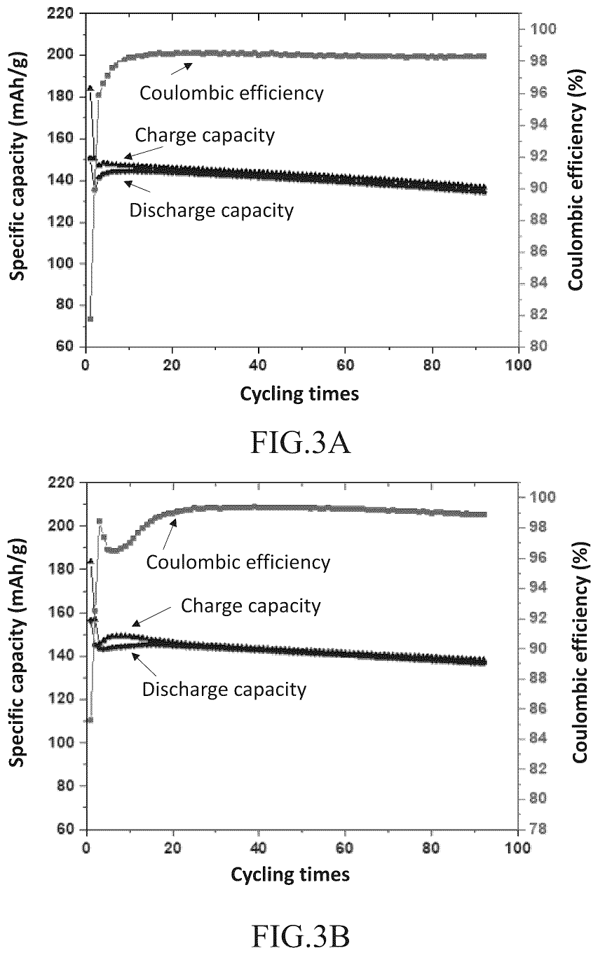

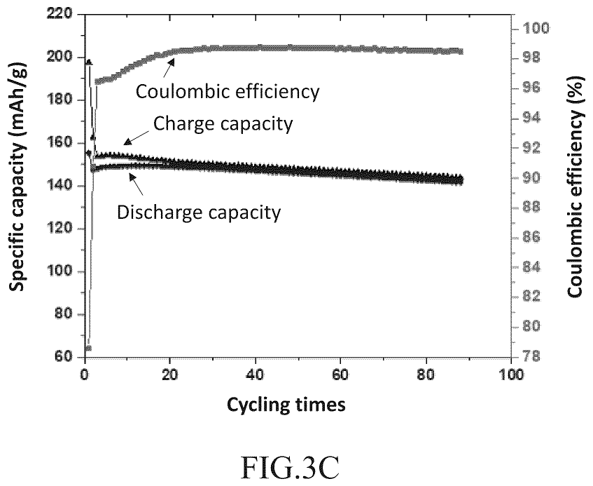

The lithium metal batteries of Examples 1B, 2B, 3B-1, 3B-2, 3B-3 were used as samples in this test example. Under one atmosphere, the charging rate of the first cycle was 0.1 C, the charging rate of the second and latter cycles was 0.5 C, the discharging rate of all cycles was 0.5 C and the voltage was 3.0 voltages (V) to 4.2V. The results were shown in FIG. 1, FIG. 2, and FIG. 3A to FIG. 3C.

As shown in FIG. 1, after 118 charge-discharge cycles, the lithium metal battery of Example 1B had total charge capacity of 137 milliamperes hour per gram (mAh/g), a coulombic efficiency of 98%, and capacity retention of 92.4%.

As shown in FIG. 2, after 170 charge-discharge cycles, the lithium metal battery of Example 2B had total charge capacity of 128 mAh/g, a coulombic efficiency of 96%, and capacity retention of 87%.

As shown in FIG. 3A, after 90 charge-discharge cycles, the lithium metal battery of Example 3B-1 had total charge capacity of 135 mAh/g, a coulombic efficiency of 98.3%, and capacity retention of 99.5%.

As shown in FIG. 3B, after 90 charge-discharge cycles, the lithium metal battery of Example 3B-2 had total charge capacity of 137 mAh/g, a coulombic efficiency of 98.9%, and capacity retention of 94.3%.

As shown in FIG. 3C, after 88 charge-discharge cycles, the lithium metal battery of Example 3B-3 had total charge capacity of 142 mAh/g, a coulombic efficiency of 98.5%, and capacity retention of 96.0%.

As shown in FIG. 1 and FIG. 2, it was found that when one modified layer was deposited between the negative electrode and the separator, or when two modified layers were deposited between the negative electrode and the separator and between the positive electrode and the separator in the lithium metal batteries of the instant disclosure, these lithium metal batteries had a coulombic efficiency of 95% or more and capacity retention of 85% or more after 100 or more charge-discharge cycles. It indicated that the modified layers prepared by the precursor solutions of the instant disclosure made aforesaid two lithium metal batteries have nice charge-discharge cycle performance.

As shown in FIG. 3A to FIG. 3C, no matter whether the precursor solution of the instant disclosure was coated on the positive electrode, the negative electrode or the separator, the modified layer prepared by the precursor solution of the instant disclosure made the lithium metal battery have high a coulombic efficiency and high capacity retention after multiple charge-discharge cycles. Specifically, after 80 or more charge-discharge cycles, aforesaid three lithium metal batteries had a coulombic efficiency of 98% or more and capacity retention of 94% or more. It indicated that the modified layer prepared by the precursor solution of the instant disclosure made the three lithium metal batteries have good charge-discharge cycle performance.

Besides, the inventor also found that no matter whether the precursor solution was dripped on the surface of the separator contacting the negative electrode to give the modified layer as Example 3A, or the precursor solution was dripped on the surface of the separator contacting the positive electrode to deposit the modified layer between the positive electrode and the separator. The charge-discharge cycle performances of former and latter lithium metal batteries were equal. That is, the latter lithium metal battery also had a coulombic efficiency of 98% or more and capacity retention of 94% or more after 80 or more charge-discharge cycles.

### Test Example 2: Galvanostatic Cycling Voltage Profile

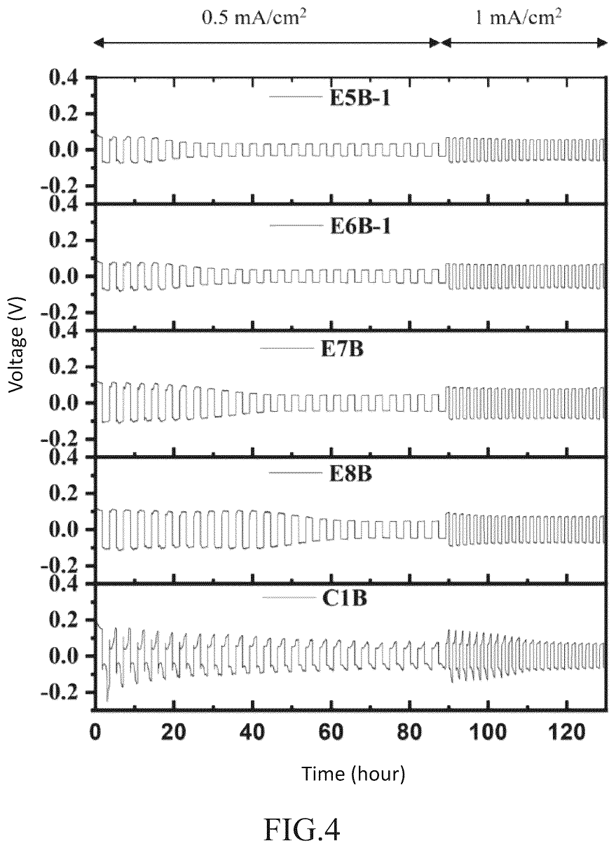

The lithium-lithium symmetric batteries of Examples 5B-1, 6B-1, 7B, 8B, and Comparative Example 1B were used as samples in this test example. Under the condition that the charge/discharge capacity was 1 milliampere hour per square centimeter (mAh/cm²), the polarization test was conducted at the current density of 0.5 milliampere per square centimeter (mA/cm²) or 1 mA/cm². The results were shown in FIG. 4.

In the lithium-lithium symmetric batteries of Examples 5B-1, 6B-1, 7B, and 8B, two modified layers were respectively deposited between the positive electrode and the separator and between the negative electrode and the separator, which was different from the lithium-lithium symmetric battery of Comparative Example 1B (without any modified layer). As shown in FIG. 4, the cycling voltage profiles of the lithium-lithium symmetric batteries of Examples 5B-1, 6B-1, 7B, and 8B were smoother than that of the lithium-lithium symmetric battery of Comparative Example 1B, which indicated that the internal resistance of lithium-lithium symmetric batteries of Examples 5B-1, 6B-1, 7B, and 8B was maintained constant during charge-discharge cycles. Besides, in the cycling voltage profiles of the lithium-lithium symmetric batteries of Examples 5B-1, 6B-1, 7B, and 8B, the absolute values of the difference between the voltage values at the peak or bottom of the profiles minus zero (0 V) were smaller than that of Comparative Example 1B, which indicated that the lower overvoltage values resulted from lithium plating and lithium stripping during the charge-discharge process in the lithium-lithium symmetric batteries of Examples 5B-1, 6B-1, 7B, and 8B, and this was beneficial to uniform lithium plating and lithium stripping behaviors so that the interface was able to become stable more rapidly.

### Test Example 3: Electrochemical Impedance Spectroscopy (EIS)

The lithium copper batteries of Examples 4B, 5B-2, 6B-2 and Comparative Example 2B were used as samples in this test example. The lithium copper batteries of Examples 4B, 5B-2, 6B-2 and Comparative Example 2B were used to simulate the lithium plating (charging) and lithium stripping (discharging) behaviors of the copper negative electrode in anode-free lithium batteries. They were also deemed as half cells. After 30 charge-discharge cycles, each sample was analyzed by alternating current (AC) impedance spectroscopy (purchased from CH Instruments, model: CHI6273e) at open circuit potential with the AC frequency of 100 kHz to 0.01 Hz.

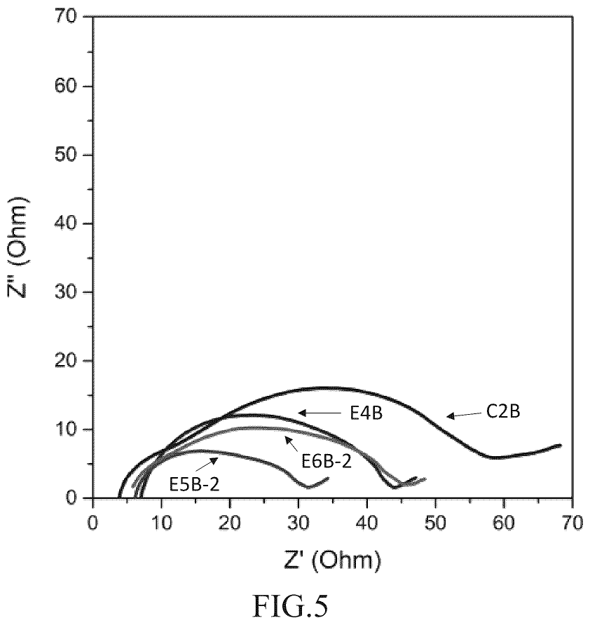

As shown in FIG. 5, the diameters of the semicircle curves of lithium copper batteries of Examples 4B, 5B-2, 6B-2 were smaller than that of the semicircle curve of lithium copper battery of Comparative Example 2B, which indicated that the lithium copper batteries of Examples 4B, 5B-2, 6B-2 had smaller charge-transfer impedance. Therefore, the lithium copper battery of the instant disclosure retained smaller internal impedance after multiple charge-discharge cycles.

### Test Example 4: Galvanostatic Charge-Discharge (GCD)

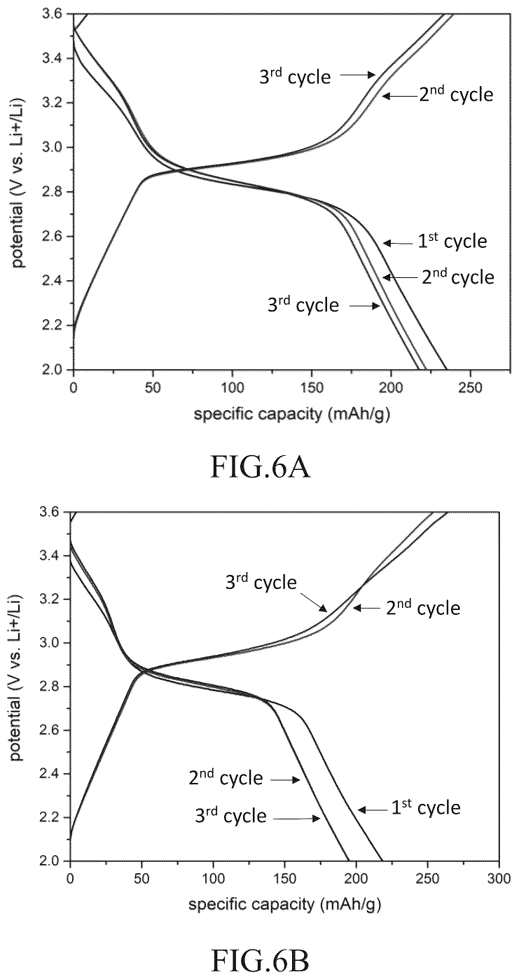

It is well known that the shuttle effect which is caused by dissolution of iodide or polysulfide of the positive electrodes during charge-discharge process in lithium iodine battery and lithium sulfur battery is one of the outstanding problems in the art. Lithium iodine batteries were subjected to this test example, and the lithium iodine batteries of Example 6C and Comparative Example 3C were used as samples. During the test, the charging/discharging rate was 0.5 C and the voltage range was 2.0 V to 3.V. As shown in FIG. 6A, the charge capacities of the first three charge-discharge cycles (voltage range: 2.0 V to 3.V) were all 220 mAh/g or more in Example 6C. As shown in FIG. 6B, the charge capacity of the second charge-discharge cycle (voltage range: 2.0 V to 3.V) had been reduced to 200 mAh/g or less in Comparative Example 3C.

The lithium iodine batteries of Example 6C and Comparative Example 3C then underwent the coulombic efficiency test. Example 6C had a coulombic efficiency of 93% and Comparative Example 3C had a coulombic efficiency of 76.9%.

The lithium iodine battery of Example 6C had a modified layer cured by the precursor solution of the instant disclosure, thereby the shuttle effect caused by migration of I⁻ and I₃⁻ dissolved in the electrolyte was suppressed and the lithium iodine battery of Example 6C had a steady charge capacity. In contrast, the charge capacity of the lithium iodine battery of Comparative Example 3C was significantly declined at the second and latter charge-discharge cycles. Similarly, in the lithium sulfur battery comprising aforesaid modified layer, the shuttle effect caused by polysulfide with negative charges could be suppressed in the charge-discharge process. Hence, the lithium sulfur battery comprising aforesaid modified layer had a high coulombic efficiency and steady charge capacity.

### Test Example 5: Observation of Lithium Dendrites

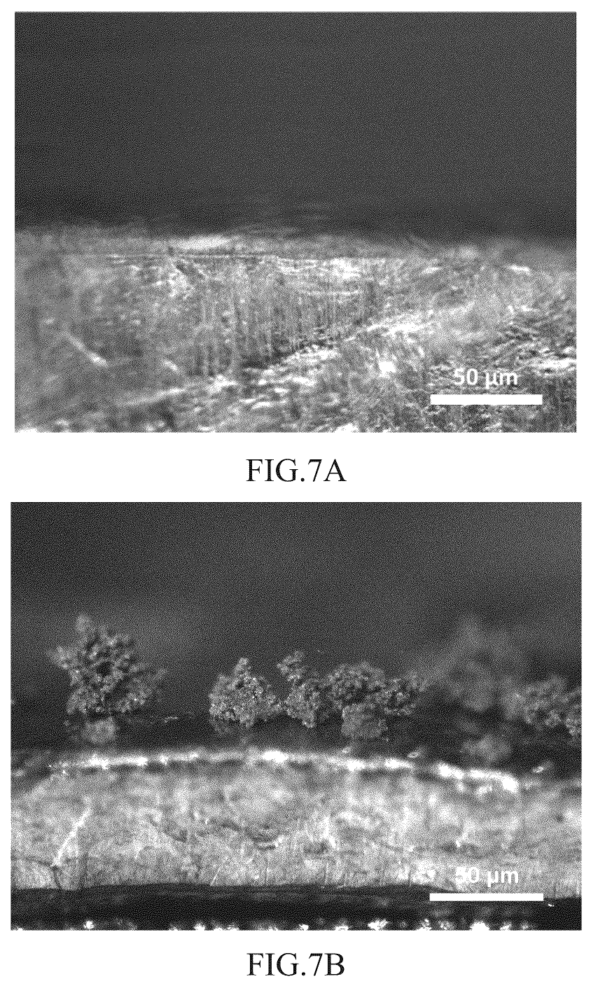

The lithium-lithium symmetric batteries of Example 9B, and Comparative Example 4B were used as samples in this test example. The current density was 0.5 mA/cm² in the charge-discharge cycles. The photographs of lithium foil negative electrodes were taken at the fifteenth (15^{th}) minute after the first lithium plating began and the surface charge capacity reached 0.125 mAh/cm². The results were shown in FIG. 7A and FIG. 7B.

As shown in FIG. 7A, no lithium dendrite formation was observed on the lithium foil negative electrode in the lithium-lithium symmetric battery 15 minutes after lithium plating. As shown in FIG. 7B, lithium dendrites with a size ranging from 35 micrometers (μm) to 50 μm were clearly observed on the lithium foil negative electrode in the lithium-lithium symmetric battery of Comparative Example 4B 15 minutes after lithium plating. Hence, the modified layer of the present disclosure was able to effectively suppress the formation of lithium dendrites on lithium electrode during the charge-discharge process.

In summary, in the lithium-based battery comprising the modified layer cured by the precursor solution of the present disclosure, the problem regarding the formation of lithium dendrites on the lithium metal electrode during the charge-discharge process is ameliorated. Specifically, the lithium-based battery shows better safety and longer charge-discharge cycling life. The modified layer can be applied to lithium sulfur batteries and lithium iodine batteries to suppress the shuttle effect during the charge-discharge process, which is beneficial to increasing the product value thereof.

1. A lithium-based battery, comprising a positive electrode, a negative electrode, a separator, a lithium electrolyte, and at least one modified layer, wherein the modified layer is formed by curing of a precursor solution, and the modified layer is deposited on the positive electrode, the negative electrode, the separator or a combination thereof;
wherein the precursor solution comprising: an active substance, a lithium salt solution and an initiator;
wherein the active substance is a monomer, an oligomer or a combination thereof;
wherein the monomer is methacrylate ester, lithium methacrylate, acrylate ester, lithium acrylate, trimethylol propane triacrylate or lithium salt of trimethylol propane triacrylate;
wherein the oligomer comprises a constitutional unit represented by 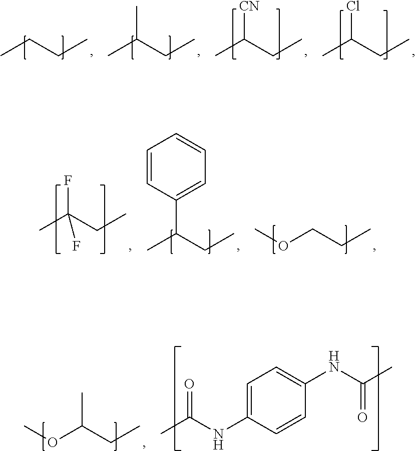
or a combination thereof, and the oligomer comprises an end structure represented by 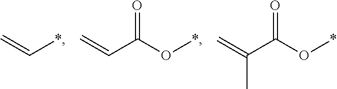
or a combination thereof;
wherein the lithium salt solution has a concentration of 0.5 M to 4 M;
wherein the initiator is 2,2-dimethoxy-2-phenylacetophenone, benzoyl peroxide, 2,2′-azobis(2-methylpropionitrile), 2-hydroxy-2-methyl-1-phenyl-1-propanone or a combination thereof;
wherein, in the precursor solution, the active substance has an amount of 5 wt % to 47.5 wt %, the lithium salt solution has an amount of 50 wt % to 94.9 wt %, and the initiator has an amount of 0.1 wt % to 5 wt %.

2. The lithium-based battery as claimed in claim 1, wherein the oligomer comprises a constitutional unit represented by 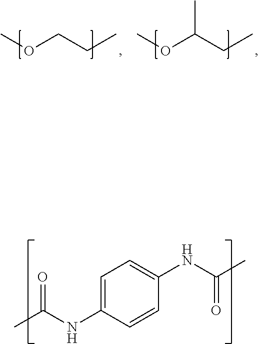
or a combination thereof, and the oligomer comprises an end structure represented by 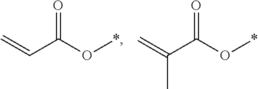
or a combination thereof.

3. The lithium-based battery as claimed in claim 1, wherein the oligomer has a number-average molecular weight of 200 to 2500.

4. The lithium-based battery as claimed in claim 3, wherein the oligomer has a number-average molecular weight of 500 to 800.

5. The lithium-based battery as claimed in claim 1, wherein the active substance is polyethylene glycol diacrylate (PEGDA), polypropylene glycol diacrylate, lithium methacrylate, lithium acrylate, trimethylol propane triacrylate or a combination thereof.

6. The lithium-based battery as claimed in claim 1, wherein the active substance has an amount of 5 wt % to 20 wt %, the lithium salt solution has an amount of 75 wt % to 94.9%, and the initiator has an amount of 0.1 wt % to 5 wt %.

7. The lithium-based battery as claimed in claim 1, wherein the lithium salt solution has a concentration of 0.8 M to 2 M.

8. The lithium-based battery as claimed in claim 1, wherein the lithium salt solution comprises a lithium salt and an organic solvent, and the organic solvent is 1,3-dioxolane, 1,2-dimethoxyethane, ethylene carbonate, ethylene methyl carbonate, dimethyl carbonate, vinylene carbonate, tetraethylene glycol dimethyl ether, dimethyl sulfoxide, acetonitrile or a combination thereof.

9. The lithium-based battery as claimed in claim 8, wherein the lithium salt is lithium bis(trifluoromethanesulfonyl)imide, lithium hexafluorophosphate, lithium tetrafluoroborate, lithium perchlorate, lithium triflouoromethanesulfonate, lithium fluoride, lithium difluorophosphate, lithium bis(oxalato)borate, lithium difluoro(oxalato)borate, lithium nitride, or a combination thereof.

10. The lithium-based battery as claimed in claim 1, wherein the precursor solution comprises an additive, and the additive is an organic compound or a metal salt;
wherein the organic compound is an oligomer comprising at least one of hydroxyl end group or amine end group, polysquarate, succinonitrile, 1,3-propane sultone, prop-1-ene-1,3-sultone, fluoroethylene carbonate, ethylene glycol, polysorbate or a combination thereof;
wherein the oligomer comprising at least one of hydroxyl end group or amine end group comprises a constitutional unit represented by 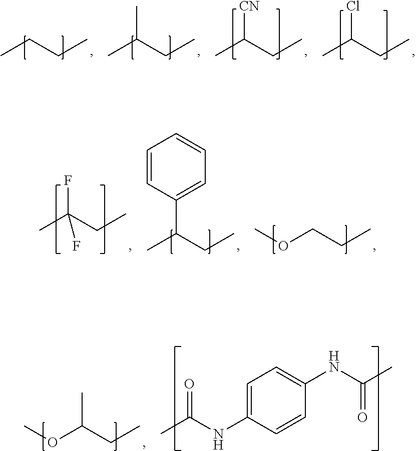
or a combination thereof;
wherein, the metal salt is lithium nitrate, sodium nitrate, potassium nitrate or a combination thereof.

11. The lithium-based battery as claimed in claim 10, wherein the oligomer comprising at least one of hydroxyl end group or amine end group comprises a constitutional unit represented by

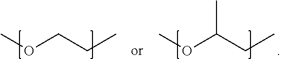

12. The lithium-based battery as claimed in claim 10, wherein the oligomer comprising at least one of hydroxyl end group or amine end group is 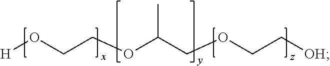
wherein x is 1 to 20; y is 1 to 40; z is 1 to 20; and x, y, and z are the same or different.

13. The lithium-based battery as claimed in claim 1, wherein the precursor solution further comprises a filler; wherein the filler is titanium dioxide, silicon dioxide, zirconium dioxide, aluminum oxide, indium tin oxide, lanthanum manganite, lithium sulfide-based particle, lithium oxide-based particle, lithium phosphate-based particle, lithium lanthanum zirconium tantalum oxide, lithium lanthanum aluminum zirconium oxide or a combination thereof.

14. he lithium-based battery as claimed in claim 1, wherein the lithium-based battery further comprises sulfur or iodine.

15. he lithium-based battery as claimed in claim 1, wherein the lithium-based battery is a lithium ion battery, a lithium metal battery, an anode-free lithium battery, a lithium sulfur battery or a lithium iodine battery.

16. he lithium-based battery as claimed in claim 1, wherein the positive electrode is a lithium nickel oxide-based electrode.
